(19) United States
(12) Patent Application Publication
(10) Pub. No.: US 2025/0131416 A1
(43) Pub. Date: Apr. 24, 2025

(54) SYSTEMS AND METHODS FOR PUSHING AUTHORIZATION INFORMATION

(71) Applicant: Simnang IP, LLC, Farmington, UT (US)

(72) Inventor: Rhett M. Roberts, Kaysville, UT (US)

(21) Appl. No.: 18/491,162

(22) Filed: Oct. 20, 2023

(51) Int. Cl. G06Q 20/38; G06Q 20/10

(52) U.S. Cl. CPC G06Q 20/382; G06Q 20/108

(57) ABSTRACT

A system may include one or more processors, and one or more non-transitory, computer-readable mediums including instructions which, when executed by the one or more processors, cause the system to receive, at an authorization engine, from an issuing processor, a transaction authorization request including transaction information, compare, by the authorization engine, the transaction information to an available balance, based on the comparison, transmit, by the authorization engine, to the issuing processor, an approval message, transmit, by the authorization engine, the transaction information to a line of credit engine, determine, by the line of credit engine, an updated available balance based on the transaction information, and transmit, by the line of credit engine, the updated available balance to the authorization engine.

### BACKGROUND

The present disclosure relates generally to the field of authorizing transactions. A complex chain of computers and servers exchanging authorization requests and authorization messages connects a merchant to a customer's bank. Merchants and customers expect an electronic exchange (e.g., a transaction, swipe, tap) to be approved quickly, but processes for querying whether a customer's account has sufficient available funds or available credit for a given transaction may be inefficient and result in computing latencies, inefficiencies, and inaccuracies.

### BRIEF DESCRIPTION OF THE DRAWINGS

FIG. 1 is a block diagram illustrating an example environment in which an authorization engine may be used, according to some implementations.

FIG. 2 is a system architecture for authorizing transactions using the authorization engine, according to some implementations.

FIG. 3 is a block diagram illustrating example details of the available credit service, according to some implementations.

FIG. 4 is a block diagram illustrating example details of the electronic ledger, according to some implementations.

FIG. 5 is a flowchart illustrating example operations in a method for approving or denying transactions.

FIG. 6 is a flow diagram depicting transaction management, according to some implementations.

FIG. 7 illustrates an example computer system 700.

It will be recognized that some or all of the figures are schematic representations for purposes of illustration. The figures are provided for the purpose of illustrating one or more embodiments with the explicit understanding that they will not be used to limit the scope or the meaning of the claims.

### DETAILED DESCRIPTION

Aspects of the present disclosure relate to pushing authorization information from, for example, a line of credit engine (or other ledger management system) to an authorization engine. The line of credit engine may calculate the authorization information, such as an available balance, and push the authorization information to the authorization engine to use in approving and denying exchanges (e.g., a card transaction, such as a swipe, a bump, a tap). Pushing authorization information from the line of credit engine to the authorization engine solves various technical problems and provides various technical improvements including conserving compute resources, conserving network resources, and providing for faster and more accurate authorizations for exchanges.

Pushing authorization information from the line of credit engine to the authorization engine conserves compute resources, as the authorization engine does not have to calculate the authorization information. For example, by calculating a real-time available balance at the line of credit engine and transmitting the real-time available balance to the authorization engine, the authorization engine is able to use the real-time available balance to authorize transactions without calculating an available balance. By concentrating calculation of the real-time available balance at the line of credit engine such that the real-time available balance is calculated, for example, only at the line of credit engine, compute resources can be conserved. Furthermore, by calculating the real-time available balance at the line of credit engine such that all fees, interest, payments, and pending transactions are applied to obtain the real-time available balance, and sending the real-time available balance to the authorization engine, transactions can be authorized at the authorization engine more accurately and with less computation than in conventional systems.

Pushing authorization information from the line of credit engine to the authorization engine provides for greater flexibility in types of accounts and numbers of accounts for which the authorization engine can provide authorization. In pushing authorization information, such as available balances, available credits, available funds, and so forth, from the line of credit engine to the authorization engine, the comparison of available funds to transaction information is simplified, allowing the authorization engine to compare available balances of various types of accounts to transaction information and allowing the authorization engine to provide authorization services for many more accounts than would be possible if the authorization engine had to perform calculations for determining the available balances.

Pushing authorization information from the line of credit engine to the authorization engine conserves network resources, as the authorization engine can aggregate transaction authorizations from multiple issuing processors and authorization information from multiple line of credit engines. In this way, the multiple line of credit engines do not each have to establish separate connections with each of the issuing processors. Instead, each line of credit engine can establish a single connection with the authorization engine and each issuing processor can establish a single connection with the authorization engine. In this way, network resources are conserved, as well as compute resources, as the multiple line of credit engines do not have to determine to which issuing processor authorization information should be sent.

In some implementations, the authorization information may be sent from the line of credit engine to the authorization engine as a single number in a standardized format. In this way, network resources are conserved, and compute resources are conserved, as the authorization engine needs to only compare the single number to incoming transaction information to determine whether to approve or deny the transaction. Providing authorization information as single numbers in a standardized format further enhances the ability of the authorization engine to aggregate multiple line of credit engines and issuing processors, further conserving network and compute resources.

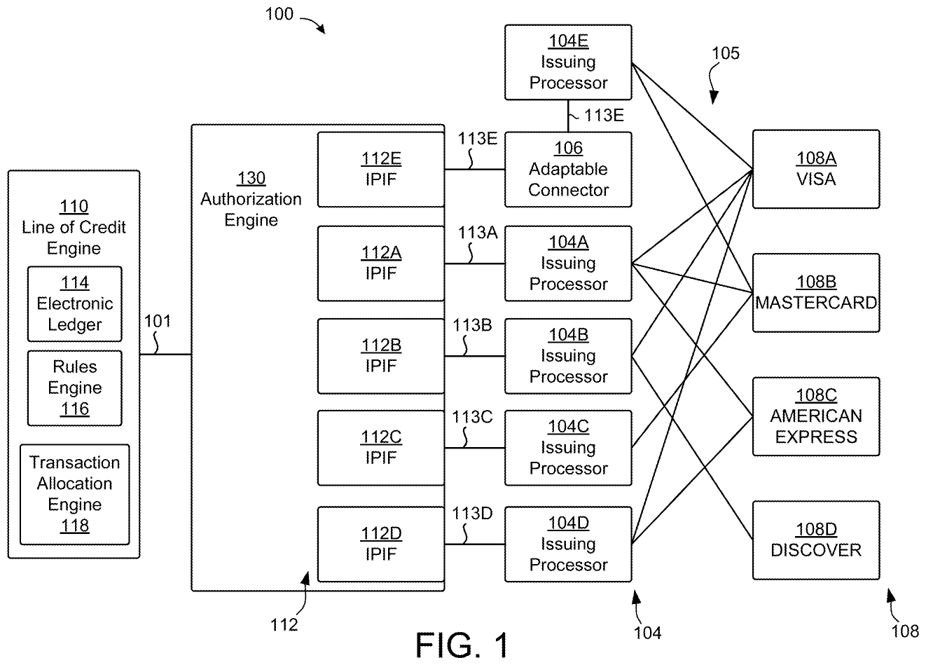

FIG. 1 is a block diagram illustrating an example environment 100 in which an authorization engine 130 may be used, according to some implementations. The authorization engine 130 may receive transaction authorization requests from multiple different issuing processors 104 received from multiple different card networks 108. The authorization engine 130 may use information from a line of credit engine 110 to authorize or deny the transaction authorization requests.

The authorization engine 130 can aggregate interfaces to the issuing processors 104. Issuing processors 104 can, in turn, implement connections to the card networks 108. For example, to implement a card program, information should be exchanged over a connection to an issuing processor 104. However, various issuing processors 104 can include computing systems which include differing data, differing data formats, or differing functions. Thus, it may be difficult for a system to interface between various issuing processors 104. For example, where different issuing processors 104 are connected to different networks, a computing system may interoperate with multiple issuing processors 104, or, incident to a selection of a new issuing processor, a computing system may be migrated between issuing processors 104. However, once integrated with a first issuing processor 104, it may be difficult to migrate to another.

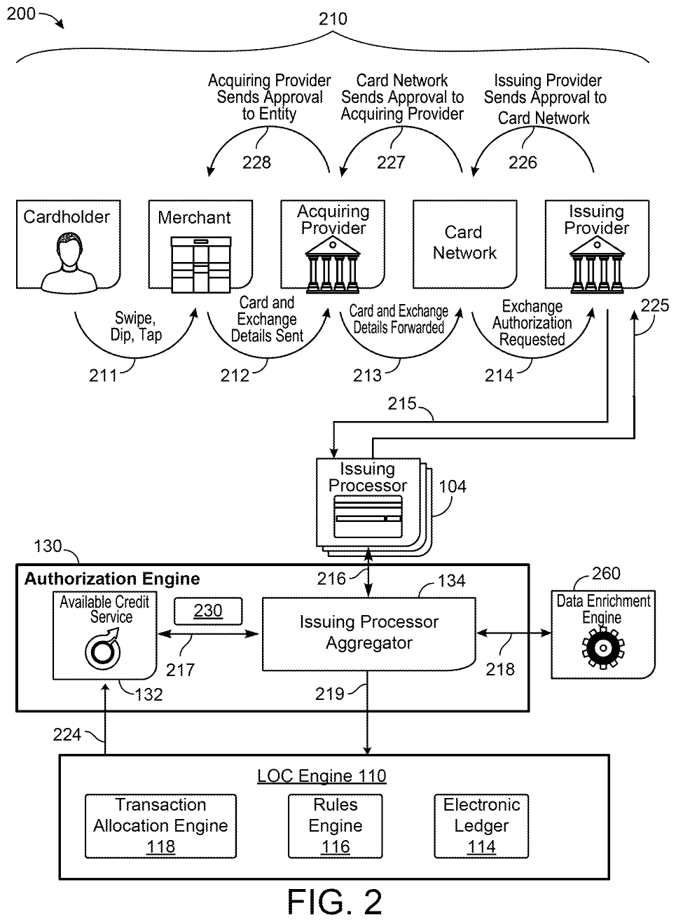

To overcome the aforementioned technical deficiencies, the authorization engine 130 can operate as middleware between a computing system and any number of issuing processors 104. For example, the authorization engine 130 can include various interfaces (e.g., issuing processor integration interfaces (IPIFs) 112, connections, etc.). The interfaces may be or can include API's, push or pull notification systems, data repositories accessible by an issuing processor 104, combinations thereof, or the like. The authorization engine 130 can communicate across the various interfaces by translating data into a format that matches an interface. Such translation can include generating or enriching data, translating information, or performing multiple operations for one issuing processor 104 to match a same functionality as another issuing processor 104, in a manner which is transparent to a computing device (e.g., at a uniform interface 101). For example, the authorization engine 130 can convert various data of an issuer entity to a uniform format (e.g., JSON) that may be transmitted to the line of credit engine 110. The line of credit engine 110 may update an electronic ledger 114 using the data, apply rules to the data using a rules engine 116, and determine an updated available balance to the authorization engine 130 using the transaction allocation engine 118, as discussed in greater detail in conjunction with FIG. 2.

The authorization engine 130 connects to a first issuing processor 104A, second issuing processor 104B, third issuing processor 104C, fourth issuing processor 104D, and fifth issuing processor 104E (collectively, issuing processors 104, also referred to as issuer processors 104, without limiting effect). The various issuing processors 104 can, in turn, connect to various networks referred to collectively as card networks 108. Particularly, the depicted system 100 includes the non-limiting illustrative examples of a VISA® network 108A, MasterCard® network 108B, American Express® network 108C, and Discover® network 108D. Each issuing processor 104 can connect to any number of card networks 108 over a respective connection 105 thereto. For example, as depicted, various issuing processors 104 may connect to at least one of the card networks 108 and/or may omit a connection to one or more card networks 108. In the example of FIG. 2, the authorization engine 130 connects to the fifth issuing processor via an adaptable connector 106, which will be explained more fully below.

An electronic ledger 114 is depicted as constituent to a line of credit engine 110. According to various embodiments, the electronic ledger 114 can couple to various system 100 components. The various components of the line of credit engine 110 and the authorization engine 130 (e.g., the electronic ledger 114, the rules engine 116, and the transaction allocation engine 118, as discussed in FIG. 2) may be associated with a uniform interface 101. However, as indicated above, the various issuing processor connections 113, can vary from each other and from the uniform interface 101. Thus, various issuing processor integration interfaces (IPIF) 112 can intermediate a corresponding issuing processor 104 from the uniform interface 101. The IPIF 112 can adapt, translate, generate, supplement, enrich, or otherwise retrieve information from various sources to adapt an entity (e.g., one or more data structures) between the issuing processor 104 and the uniform interface 101. For example, the adaptation can include a translation for a uniform interface 101 associated with the electronic ledger 114 of FIG. 1.

The uniform interface 101 can include an application programming interface (API) which may be configured to receive data according to a pre-determined format. For example, the uniform interface 101 can arrange information according to JSON, XML, or other format. The authorization engine 130 can exchange information with the uniform interface 101 (e.g., receive from, or convey to). For example, the authorization engine 130 can retrieve data of an issuer entity from other connections including other APIs, FTP sites, or other repositories, push notification, emails, or other data conveyance paths and adapt said data to the uniform interface.

In some implementations, multiple line of credit engines may connect to the authorization engine 130. In an example, multiple lenders may send available balances associated with customer accounts to the authorization engine 130 for the authorization or denial of transactions. In some implementations, the authorization engine 130 may include multiple separate instances, such that each line of credit engine connects to a corresponding instance of the authorization engine 130. In this way, each respective line of credit engine may send balance information to a corresponding authorization engine 130 which is specific to the respective line of credit engine and which includes balance information of only the respective line of credit engine.

The authorization engine 130 couples to the various issuing processors 104 via respective connections. For example, various connections shown as direct connections, such as a first connection 113A between the first issuing processor 104A and the first IPIF 112A can include a logically direct connection (e.g., an issuer entity portion conveyed by the first IPIF 112A may be the same as is received by the issuing processors 104). Such connections can include various intermediary devices such as switches, routers, cables, or so forth, which can include appendages or concatenations of various checksums, framing or packetizing padding or data, or so forth. As depicted, a second connection 113B between a second IPIF 112B and a second issuing processor 104B; third connection 113C between a third IPIF 112C and a third issuing processor 104C; or fourth connection 113D between a fourth IPIF 112D and a fourth issuing processor 104D can likewise interface without logical intermediation. The various IPIF 112A, 112B, 112C, 112D, 112E may be referred to, collectively, as IPIF 112.

According to the present disclosure, the authorization engine 130 can implement one or more interfaces to couple to any number of issuing processors. One or more interfaces generated by the authorization engine 130 may be configured to couple to an adaptable connector 106 to connect to the issuing processor 104. For example, the adaptable connector 106 can implement any of the translations (e.g., generations) discussed herein. That is, the adaptable connector 106 may be adaptable to a previously generated interface, and may further provide a connector for a uniform interface 101. For example, the adaptable connector 106 can implement a data enrichment operation, such as by comparing a predefined list of merchants to a location, MCC, or other issuer entity.

In some embodiments, the adaptable connector 106 may be or include an application operating on an external computing device from the authorization engine 130. The adaptable connector 106 can operate as middleware between the authorization engine 130 and the issuing processor 104E. In doing so, the adaptable connector 106 can transfer data between the issuing processor 104 and the authorization engine 130 (e.g., through the IPIF 112E), in some cases without any modification. Such may be advantageous, for example, when systems connect with the authorization engine 130 that already are connected to an issuing processor. Such systems can operate to route communication between the authorization engine 130 and the issuing processor to perform different functions, such as to complete transactions.

As depicted, and in some embodiments, the adaptable connector 106 intermediates a fifth connection 113E between the fifth IPIF 112E and a fifth issuing processor 104E. The adaptable connector 106 can perform any of the operations of the various IPIF 112. For example, the adaptable connector 106 can perform a first portion of enrichment operations for translations between the various transactions and the uniform interface 101, and the fifth IPIF 112E can perform any additional or further operations. For example, the authorization engine 130 can lack a connection 113 to directly interface with the fifth issuing processor 104E, and a merchant can include a pre-defined interface to couple to an issuing processor 104. The pre-defined interface can include various connectors to data enrichment tables, servers, or other data sources for an issuer entity such that including a connection to the adaptable connector 106 can provide a translator to the uniform interface with obviates at least some operations of architecting an IPIF 112E to couple directly to the fifth issuing processor 104E (e.g., defining or consolidating data sources to generate instances of the issuer entity which are mappable or translatable to the uniform interface).

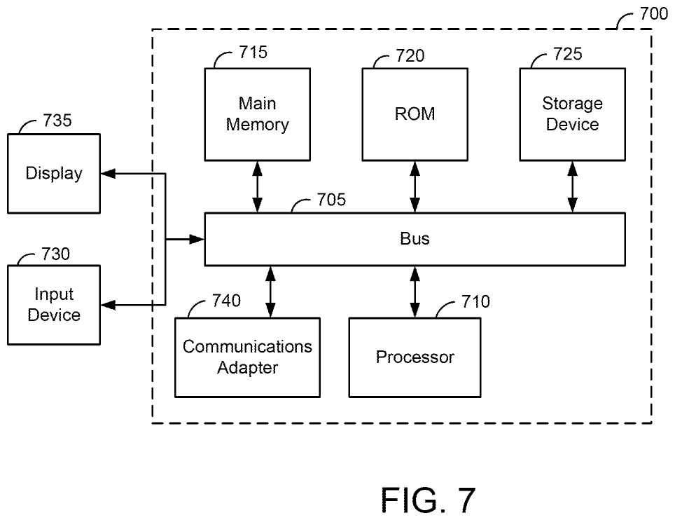

Each system or device in the computing environment may include one or more processors, memories, network interfaces (sometimes referred to herein as a “network circuit”) and user interfaces. The memory may store programming logic that, when executed by the processor, controls the operation of the corresponding computing system or device. The memory may also store data in databases. For example, the system 100, or the various components thereof can include one or more components or structures of functionality of computing devices depicted in FIG. 7. The network interfaces may allow the computing systems and devices to communicate wirelessly or otherwise, e.g., via a network. The various components of devices in the computing environment may be implemented via hardware (e.g., circuitry), software (e.g., executable code), or any combination thereof. Systems, devices, and components in FIG. 1 may be added, deleted, integrated, separated, and/or rearranged in various embodiments of the disclosure.

FIG. 2 is a system architecture 200 for authorizing transactions using the authorization engine 130, according to some implementations. The system architecture 200 depicts the process of a cardholder performing a transaction and the components of an authorization engine 130 (in particular, an issuing processor aggregator 134 and an available credit service 132) receiving transaction data from a provider for processing the transaction. An illustrated computing environment 210 depicts the process of exchanging information between the cardholder, merchant, providers and card networks 108. For example, at 211 the user can perform a swipe action (e.g., dip, tap or otherwise provide card information to a merchant), such as by interfacing a physical card or mobile wallet with a point of sale (POS) terminal. At 212, the card and transaction details (or data) may be sent to an acquiring provider (e.g., acquiring financial institution (FI)). At 213, the acquiring provider can forward the card information (or other requital form) and transaction details to a card network 108, and at 214 the card network 108 can request, from an issuing provider, a transaction authorization (e.g., authorizing the transaction). A “card” can refer to or correspond to an account corresponding to one or more ledgers, or a physical or virtual token associated therewith. For example, a card can correspond to a physical credit, debit, or other stored value account. The card may correspond to a virtual card of a mobile wallet, or other stored value account. A card can refer to a token used according to a physical presence of a token (e.g., mobile wallet or credit card). A card can refer to another operative connection, such as a token (e.g., account number, virtual account number, or other information) provided via a wired or wireless network. A card can refer to a reference to pre-communicated information, such as an indication to process an exchange based on previously converted credentials (e.g., a saved payment card).

It will be understood that the actions 215-225 described herein may be executed by the authorization engine 130 (and components thereof) and devices connected thereto, in particular, issuing processors 104, a data enrichment engine 260 and an available credit service 132. The authorization engine 130 may include the issuing processor aggregator 134 and the available credit service 132. In some implementations, the authorization engine 130 may include the data enrichment engine 260. In some implementations, the issuing processor aggregator 134 includes the available credit service 132. In some implementations, the authorization engine 130 is part of the line of credit engine 110. In some implementations, the authorization engine 130 is separate from the line of credit engine 110 and transmits information to and receives information from multiple line of credit engines. The available credit service 132 can include multiple entries of available balances from the electronic ledger 114 of the line of credit engine 110. The available credit service 132 can include multiple entries of available balances from multiple electronic ledgers of the multiple line of credit engines.

The authorization engine 130 may approve or deny the transaction. The authorization engine 130 may approve or deny the transaction in response to the transaction authorization request. In some embodiments, the authorization engine 130 may include or otherwise utilize a comparator 230 to compare transaction data (e.g., an amount) against an available balance. In some embodiments, the comparator 230 of the authorization engine 130 may approve or deny the transaction based on information from the available credit service 132. In some implementations, the issuing processor aggregator 134 may approve or deny the transaction based on information from the available credit service 132. At 215, the issuing provider can provide to the issuing processor 104 transaction data of a transaction. In some implementations, at 215, the issuing processor 104 can query the issuing provider on a periodic basis for new changes. At 216, the transaction and transaction data may be encrypted and/or a secure communication channel (e.g., secure socket layer (SSL), transport layer security (TLS), etc.) may be established between the issuing processor 104 and the issuing processor aggregator 134. At 216, issuer data (e.g., data fields, data structures, information disposed within computer-readable instructions, or other information associated with card creation, administrative functions, or transaction management) may be exchanged over a connection between the issuing processor 104 and the issuing processor aggregator 134. The issuer data may be exchanged according to one or more messages over one or more communications channels, such as an encrypted channel, as provided above. The messages may be provided as point to point messages, or by a provision of any number of data fields of the issuer data to a shared resource (e.g., a shared memory, a mutually accessible server location, or another data repository).

At 217, the issuing processor aggregator 134 can obtain a real-time available balance associated with an account of the cardholder from the available credit service 132. The issuing processor aggregator 134 may compare the transaction data to the real-time available balance to authorize or deny the transaction. The real-time available balance may include various parameters associated with the account of the cardholder. In an example, a transaction exceeding the real-time available balance, a transaction limit, daily spend limit, MCC category limit, or located in a restricted area may be indicative of a denial. The issuing processor aggregator 134 may authorize or deny the transaction based on the comparison of the transaction data to the real-time available balance. In an example, if a transaction amount of the transaction is less than the real-time available balance, the transaction may be approved. In an example, if a transaction amount of the transaction is greater than the real-time available balance, the transaction may be denied. The issuing processor aggregator may, upon determining whether the approve or deny the transaction, send an authorization message or denial message to the issuing processor. In some implementations, the issuing processor aggregator 134 sends the authorization message or denial message to the issuing processor 104 immediately upon determining whether to approve or deny the transaction. In this way, the issuing processor aggregator 134 may approve or deny the transaction within a time period required for the transaction approval.

Alternatively or in addition, in some embodiments, at 217 the issuing processor aggregator 134 can provide exchange data to the available credit service 132. The available credit service 132 may compare the transaction data to the real-time available balance to authorize or deny the transaction. The available credit service 132 may authorize or deny the transaction based on the comparison of the transaction data to the real-time available balance. In some embodiments, at 217, both the available credit service 132 and the issuing processor aggregator 134 provide information to the authorization engine 130, which may compare the transaction data to the real-time available balance to authorize or deny the transaction. In some embodiments, the authorization engine 130 may include a comparator 230 to compare the transaction data to the real-time available balance to authorize or deny the transaction.

At 218, the exchange data can be augmented or enriched with additional data (or supplemental data) from a data enrichment engine (or source, partner) 260. The additional data may, for example, provide additional information about a merchant or other participant to an exchange. The additional information can enable additional searching, sorting, routing, etc. of an exchange according to additional features or attributes. Additionally or alternatively, at 218, the transaction data may be sent (e.g., securely) to a data enrichment engine 260. The data enrichment engine 260 may scrub and/or clean (e.g., fixing incorrect, incomplete, duplicate or otherwise erroneous data in the data set, detecting and correcting corrupt or inaccurate records from a record set, table, or database and by incomplete, incorrect, inaccurate, or irrelevant parts of the data and then replacing, modifying, or deleting the dirty or coarse data). The data enrichment engine 260 may analyze and/or supplement the transaction data to obtain enriched transaction data. In an example, the data enrichment engine 260 determines a spending category for the transaction based on the transaction data. In some implementations, the data enrichment engine 260 is part of the issuing processor aggregator 134. In some implementations, the data enrichment engine 260 is part of a separate, third-party service. In an example, the data enrichment engine 260 may be executed on or hosted on a server separate from a server on which the issuing processor aggregator 134 is executed or hosted.

In some implementations, the issuing processor aggregator 134 queries the available credit service 132 for the real-time available balance at 217 and sends the transaction data to the data enrichment engine 260 at 218 in parallel. The issuing processor aggregator 134 may compare the transaction data to the real-time available balance to approve or deny the transaction independent of obtaining the enriched transaction data from the data enrichment engine 260. In this way, there is no delay in approving or denying the transaction due to the data enrichment engine 260.

At 219, the transaction data and/or the enriched transaction data may be posted or sent to the line of credit engine 110. The line of credit engine 110 can perform any number of operations based on the receipt of the transaction data, such as adjustment or appendage to the electronic ledger 114. For example, the line of credit engine 110 can adjust an available balance, number of transactions per day, transaction history, or other information. The line of credit engine 110 may apply pending transactions, fees, interest, payments, and other calculations to the electronic ledger 114 to obtain the real-time available balance. The real-time available balance may represent a real-time, accurate representation of the available balance, taking into account all factors that affect the available balance, such as pending transactions, fees, interest, payments, and other calculations. The real-time available balance may differ from an estimated available balance calculated by tracking transactions and payments. Conventional systems may rely upon estimated available balances calculated at the issuing processor 104. Use of the real-time available balance provides for more accurate authorization or denials of transactions while reducing a computing load at the issuing processor 104 and/or the authorization engine.

The line of credit engine 110 may transmit, at 224, the real-time available balance to the available credit service 132. The available credit service 132 may store the real-time available balance for comparison with transactions, as discussed herein. The issuing processor aggregator 134 may query the available credit service 132 to compare a current transaction to the real-time available balance. The real-time available balance stored at the available credit service 132 may be updated in response to each transaction. In an example, once a transaction is approved, the issuing processor aggregator 134 sends the transaction data to the line of credit engine 110 which updates the real-time available balance and transmits the updated real-time available balance to the available credit service 132.

In some implementations, the line of credit engine 110 generates at 224, the information associated with the transaction data by processing the transaction data using the rules engine 116. The rules engine 116 may apply one or more rules to the transaction data to determine one or more categories or buckets associated with the transaction. In an example, the rules engine 116 may determine, based on the transaction data, that the transaction is a vehicle maintenance purchase. In an example, the rules engine 116 may determine, based on the transaction data, that the transaction is a reimbursable purchase. In an example, the rules engine 116 may determine, based on the transaction data, that the transaction is a business purchase. In an example, the rules engine 116 may determine that the transaction is a tax-deductible purchase.

The transaction allocation engine 118 may allocate the transaction to one or more categories or buckets based on the determinations of the rules engine 116. The transaction allocation engine 118 may select one or more of the determined categories or buckets determined by the rules engine 116. In an example, the rules engine 116 may determine that the transaction belongs to two buckets and the transaction engine 118 may allocate the transaction to one of the buckets, both of the buckets, or split the transaction between the two buckets. In an example, the rules engine 116 may determine a first probability that the transaction belongs to a first bucket and a second, higher probability that the transaction belongs to a second bucket, and the transaction engine 118 allocates the transaction to the second bucket. In some implementations, the transaction engine 118 may allocate the transaction to the one or more categories or buckets by updating the electronic ledger 114. In some implementations, the transaction engine 118 may allocate the transaction to the one or more categories or buckets by updating a bucket ledger.

At 225, the issuing provider may be provided a response. The response may include an approval message. The response may include a denial message. At 226, the issuing provider sends an approval to the card network. At 227, the card network can send an approval to the acquiring provider. At 228, the acquiring provider can send the approval to the merchant. The various approvals may or may not include the approval message sent by the issuing processor 104. In an example, once the merchant receives the approval, the merchant completes the transaction by delivering goods or services to the cardholder.

The receipt of the approval, by the merchant, may be received prior to an expiration of a predefined time. For example, the merchant can include a timeout such that the merchant can locally deny a transaction upon the predefined time (e.g., five seconds) elapsing. Such a technique can improve operational security, such as to reduce a time used by a man-in-the-middle attack which may incur further delay. However, the various operations can include operations across a network which are not generally completed prior to the elapsing of the predefined time. For example, the issuing processor aggregator 134 can gather data from various data sources associated with an issuer entity and convey the issuer entity to the line of credit engine 110 over a uniform interface. The uniform interface may be configured to reduce a number of operations performed by the line of credit engine 110, such as by providing the issuer entity according to a same data structure (e.g., an electronic data structure) as the electronic ledger. That is, the conveyance of information at 219 can include a conveyance of information over a uniform interface. Such a retrieval of disaggregated system and provision of data corresponding to the electronic ledger 114 of the line of credit engine 110 can reduce latency of communication, such that the transaction can process prior to an expiration of the transaction at the merchant POS. In addition, use of the real-time available balance may result in faster, more accurate determinations of approval or denial relative to conventional systems, as discussed herein.

The available credit service 132, the issuing processor aggregator 134, and the comparator 230 can each include one or more processing units, circuitry, or other logic device such as programmable logic array engine, or module, can be implemented in software and/or hardware, and can be separate components or a single component of an authorization engine 130. Similarly, the authorization engine 130 include one or more processing units, circuitry, or other logic device such as programmable logic array engine, or module and can be implemented in software and/or hardware. The rules engine 116 and the transaction allocation engine 118 can each include one or more processing units, circuitry, or other logic device such as programmable logic array engine, or module, can be implemented in software and/or hardware, and can be separate components or a single component of a LOC engine 110. Similarly, the LOC engine 110 include one or more processing units, circuitry, or other logic device such as programmable logic array engine, or module and can be implemented in software and/or hardware.

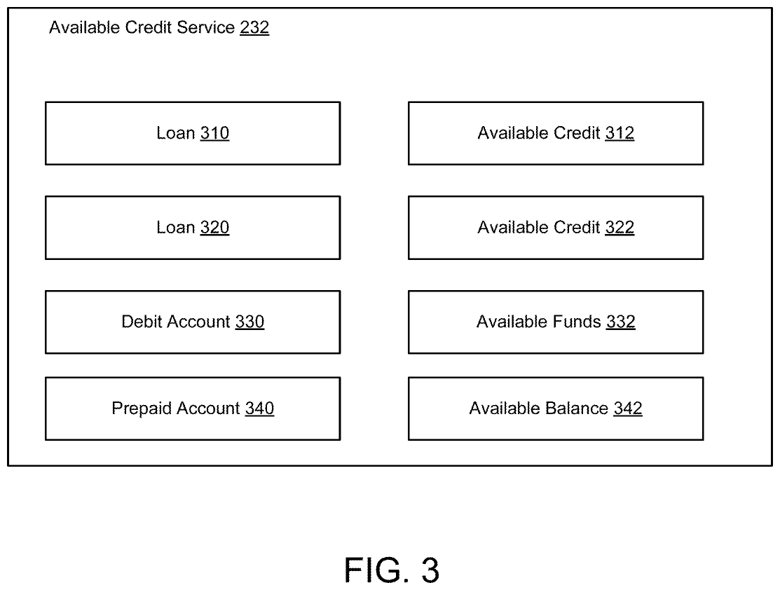

FIG. 3 is a block diagram illustrating example details of the available credit service 132, according to some implementations. The example details are provided for illustration purposes and are not limiting. The available credit service 132 may include some of the example details shown, all of the example details shown, none of the example details shown, and/or different details.

The available credit service 132 may include a first loan 310, a second loan 320, a debit account 330, and a prepaid account 340. For ease of communication, the available credit service 132 is referred to as including the first loan 310, the second loan 320, the debit account 330, and the prepaid account 340, and the available credit service 132 may include data entries corresponding to each, a single data structure including data entries for each, separate data structures including data entries for each, and/or a database including data entries for each of the first loan 310, the second loan 320, the debit account 330, the prepaid account 340, the available credit service 132, and corresponding data. Similar language is used for ease of communication when discussing other concepts, data, or digital information.

The available credit service 132 may include a first available credit 312, a second available credit 322, an available funds 332, and an available balance 342. The first available credit 312 may correspond to the first loan 310, representing an available credit of the first loan 310. The first available credit 312 may be a real-time available balance or real-time available credit, as discussed in FIG. 2. The second available credit 322 may correspond to the second loan 320, representing an available credit of the second loan 320. The second available credit 322 may be a real-time available balance or real-time available credit, as discussed in FIG. 2. The available funds 332 may correspond to the debit account 330, representing available funds of the debit account 330. The available funds 332 may be a real-time available balance or real-time available funds, as discussed in FIG. 2. The available balance 342 may correspond to the prepaid account 340, representing an available balance of the prepaid account 340. The available balance 342 may be a real-time available balance as discussed in FIG. 2. Used generally herein, the term “real-time available balance” refers to any type of real-time amount of available funds or credit associated with an account.

The available credit service 132 may include accounts and corresponding balances, funds, or credits, allowing for flexibility of accounts which may be provided to the issuing processor aggregator 134 for comparison with transaction data. The available credit service 132 may include real-time available balances, as discussed in FIG. 2, for each of the accounts included in the available credit service 132. In an example, the first loan 310 is a credit card account and the first available credit 312 is a real-time available credit of the credit card account with all fees, interest, payments, and pending transactions applied. In an example, the second loan 320 is a revolving line of credit and the second available credit 322 is a real-time available credit of the revolving line of credit with all fees, interest, payments, and pending transactions applied. In an example, the debit account 330 is a debit card account and the available funds 332 is a real-time available funds of the debit card account with all fees, payments, and pending transactions applied. In an example, the prepaid account 340 is a gift card account and the available balance 342 is a real-time available balance of the gift card account with all fees, deposits, and pending transactions applied. By receiving real-time available balances, available credits, and available funds, the available credit service 132 is able to store real-time values for loans, credit cards, debit cards, gift cards, and other accounts for comparison against transaction data. In this way, the available credit service 132 is able to flexibly provide data for comparison against transaction data for a variety of different account types. This represents a technical improvement over conventional systems, which are generally limited to applying transaction data to estimated balances for a single type of account. By consolidating the balance information for multiple types of accounts in the available credit service 132, the system conserves network connections and reduces latency. Furthermore, by sending real-time balances of the various account types to the available credit service 132 from the line of credit engine 110, the system reduces consumption of compute resources.

The available credit service 132 includes accounts associated with one or more users. In some implementations, the first available credit 312, the second available credit 322, the available funds 332, and the available balance 342 are accounts associated with a single user. In some implementations, the first available credit 312, the second available credit 322, the available funds 332, and the available balance 342 are accounts each associated with a different user. In some implementations, one or more of the first available credit 312, the second available credit 322, the available funds 332, and the available balance 342 are accounts associated with one or more users. In this way, the available credit service 132 is able to provide account information and corresponding real-time balances for accounts of various types and associated with various users.

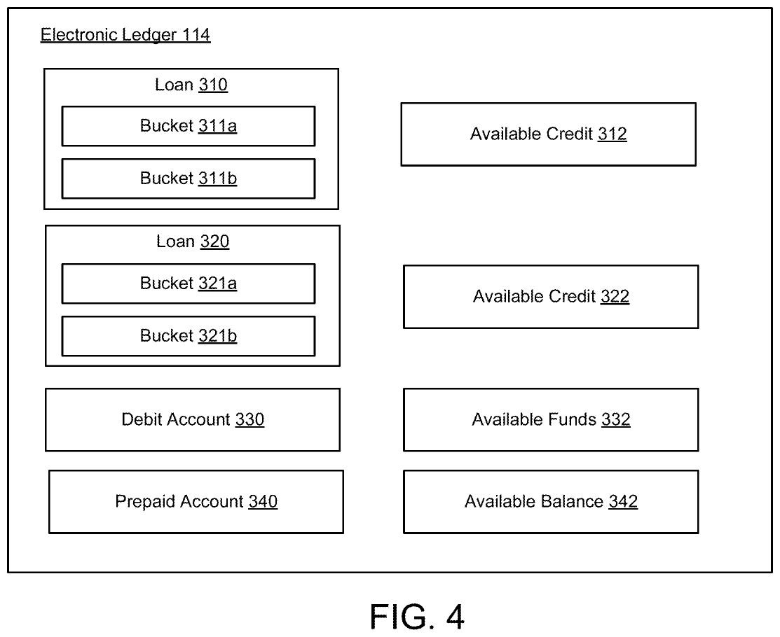

FIG. 4 is a block diagram illustrating example details of the electronic ledger 114, according to some implementations. The electronic ledger 114 may include the first loan, the second loan, the debit account 330, the prepaid account 340, the first available credit 312, the second available credit 322, the available funds 332, and the available balance 342 as included in the available credit service 132 in FIG. 3. The information in the electronic ledger 114 may correspond to the information in the available credit service 132, as the line of credit engine 110 transmits information including real-time available balance information to the authorization engine 130.

The electronic ledger 114 may include account information and balances for a variety of different account types. The electronic ledger 114 and/or the line of credit engine 110 may perform calculations for each account based on its account type and transactions associated with the account. In an example, the electronic ledger 114 may calculate interest, fees, and payments for a credit card account, a loan account, or a revolving line of credit account. In an example, the electronic ledger 114 may calculate deposits and withdrawals for a debit account. The electronic ledger 114 may calculate real-time available balances for each account based on its account type and transactions associated with the account. The line of credit engine 110 may send the real-time available balances to the available credit service 132. In this way, the available credit service 132 is able to provide real-time available balances to the issuing processor aggregator 134 for comparison to transaction data without performing any calculations. By concentrating the calculation of the real-time available balances at the line of credit engine 110, the available credit service 132 is able to provide balance information for a variety of account types and conserve computing resources.

The electronic ledger 114 may include a first bucket 311a and a second bucket 311b for the first loan 310. The first bucket 311a may represent a first category of transaction for the first loan 310 and the second bucket 311b may represent a second category of transaction for the first loan 310. The first bucket 311a and the second bucket 311b, referred to collectively as buckets 311, provide additional data to a user regarding transactions conducted using the first loan 310. A user may create the buckets 311 and assign amounts to the buckets to track and/or control spending. In an example, the first bucket 311a may be a fuel expenses bucket and the second bucket 311b may be an office supplies bucket. In this example, the transaction allocation engine 118 may assign transactions to the fuel expenses bucket, the office supplies bucket, or another bucket of the first loan 310 to allow the user to track and/or control spending across these categories.

The electronic ledger 114 may include a first bucket 321a and a second bucket 321b for the second loan 320. The first bucket 321a may represent a first category of transaction for the second loan 320 and the second bucket 321b may represent a second category of transaction for the second loan 320. The first bucket 321a and the second bucket 321b, referred to collectively as buckets 321, provide additional data to a user regarding transactions conducted using the second loan 320. A user may create the buckets 321 and assign amounts to the buckets to track and/or control spending. In an example, the first bucket 321a may be a reimbursement expenses bucket and the second bucket 321b may be a tax-deductible expenses bucket. In this example, the transaction allocation engine 118 may assign transactions to the reimbursement expenses bucket, the tax-deductible expenses bucket, or another bucket of the second loan 320 to allow the user to track and/or control spending across these categories.

In some implementations, the electronic ledger 114 includes buckets for the debit account 330 and/or the prepaid account 340.

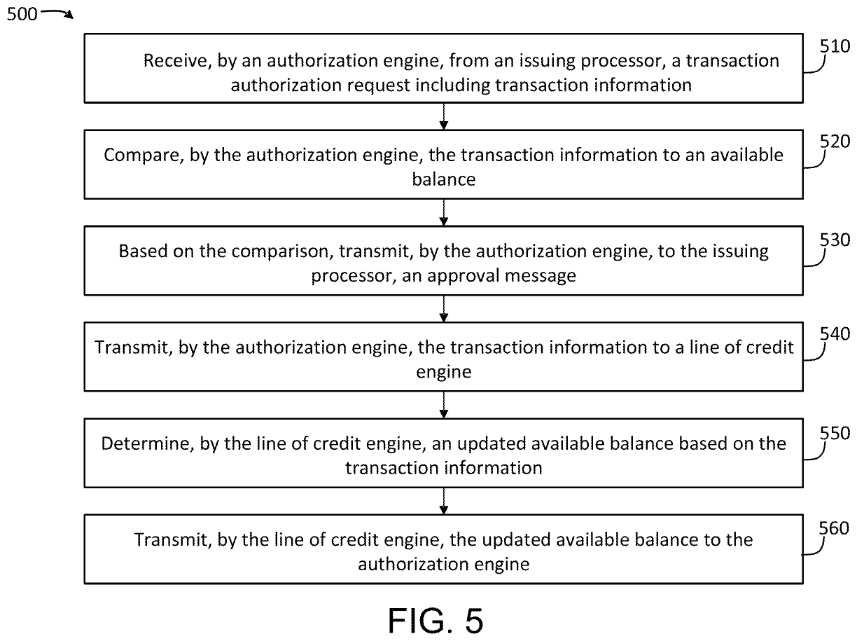

FIG. 5 is a flowchart illustrating example operations in a method 500 for approving or denying transactions. The method 500 may be performed by one or more components of the system architecture 200 of FIG. 2. The method 500 may be performed by the authorization engine 130 and/or the line of credit engine 110. The method 500 may include more, fewer, or different operations. The operations may be performed in the order shown, in a different order, or concurrently.

An authorization engine may receive 510, from an issuing processor, a transaction authorization request including transaction information. The transaction authorization request may be to approve or deny a transaction. The transaction may be initiated by a cardholder at a merchant, prompting a chain of messages between various computing devices and/or servers to authorize the transaction. The transaction information may include a transaction amount and an account identifier of an account associated with the cardholder. In some implementations, the transaction information may include a merchant identifier, one or more merchant category codes (MCCs), a transaction type (e.g., online, in-person, swipe, chip, tap, etc.), a transaction location, a transaction description, an identifier of goods or services, and/or other information regarding the transaction. The authorization request may include some or all of the transaction information. In some implementations, the authorization request includes only the information required by the authorization engine to authorize or deny the transaction. In an example, the authorization request may include a transaction amount so the authorization engine can determine whether the account associated with the cardholder has sufficient available funds or sufficient available credit for the transaction.

The authorization engine may compare 520 the transaction information to an available balance. Comparing the transaction information may include comparing a transaction amount of the transaction information to the available balance. The available balance may be received from a line of credit engine. The available balance may be a real-time available balance that accurately reflects the real-time available balance calculated at the line of credit engine. The line of credit engine may calculate the real-time available balance, applying all fees, interest, pending charges, payments, and other inputs that affect the available balance and transmit the real-time available balance to the authorization engine. The authorization engine may compare the transaction information to the real-time available balance to accurately determine whether the account has sufficient available funds and/or available credit to complete the transaction. In this way, the authorization engine can, without calculating the available balance, use the real-time available balance provided by the line of credit engine to determine whether to approve or deny the transaction. In some implementations, the line of credit engine may push the real-time available balance to the authorization engine. In an example, each time a calculation is applied to the real-time available balance, or each time the real-time available balance is updated, the line of credit engine pushes the real-time available balance, or updated real-time available balance to the authorization engine.

The authorization engine may transmit 530, based on the comparison, an approval message to the issuing processor. The authorization engine may transmit 530 the approval message to the issuing processor based on the available balance indicating that sufficient funds or credit are available to pay for the transaction. In an example, the authorization engine transmits the approval message based on the available balance being higher than the transaction amount. The authorization engine may transmit 530 the approval message based on the authorization engine determining to approve the transaction.

The authorization engine may, based on the comparison, deny the transaction. The authorization engine may deny the transaction based on the available balance indicating that the account has insufficient funds or credit available to pay for the transaction. The authorization engine may determine to deny the transaction. The authorization engine may transmit a denial message to the issuing processor to deny the transaction. In some implementations, the authorization engine may allow a response time to expire in order to deny the transaction. In some implementations, use of the real-time available balance by the authorization engine may cause a transaction to be approved or denied when conventional systems would not approve or deny the transaction. In an example, use of the real-time available balance by the authorization engine may cause the authorization engine to approve a transaction that would be denied by a conventional system based on the real-time available balance reflecting a payment or pending transaction on the account. In an example, use of the real-time available balance by the authorization engine may cause the authorization engine to deny a transaction that would be approved by a conventional system based on the real-time available balance reflecting a fee or pending transaction on the account. In an example, a conventional system may require synchronization between an issuer processor and a line of credit ledger, allowing a transaction to be incorrectly approved when fees and/or finance charges cause the available balance to be less than the transaction amount. In this example, the transaction may be approved due to the available balance seen by the issuer processor being stale and artificially high, as it does not include the fees and/or finance charges. In an example, a conventional system may require a line of credit ledger of a bank to approve transactions, where approved (but not yet cleared) transactions are not reflected in the line of credit ledger, causing transactions to be incorrectly approved based on the available balance in the line of credit ledger being stale and artificially high, as it does not reflect the approved but not cleared transactions. In this example, transactions may be incorrectly denied based on the available balance in the line of credit ledger being stale and artificially low, as it does not reflect transactions that were approved but which then expired without being cleared.

The authorization engine may transmit 540 the transaction information to the line of credit engine. The authorization engine may transmit 540 the transaction information to the line of credit engine in response to the authorization engine approving the transaction and/or receiving a notification that the transaction has been completed.

In some implementations, the method 500 includes transmitting, by the authorization engine, the transaction information to a data enrichment engine and receiving, by the authorization engine, from the data enrichment engine, enriched transaction information. The enriched transaction information may include additional information, such as MCC determinations, transaction categories, rewards program information, spending metrics, and other information. In some implementations, transmitting, by the authorization engine, the transaction information to the line of credit engine includes transmitting the enriched transaction information to the line of credit engine. The line of credit engine may use the enriched transaction information to determine one or more buckets or categories for the transaction.

The line of credit engine may determine 550 an updated available balance based on the transaction information. In some implementations, determining 550 the updated available balance includes updating a balance category or bucket of the available balance. Updating the balance category or bucket of the available balance may include determining, based on the transaction information, a transaction category corresponding to the balance category or bucket. In an example, the line of credit engine may determine that the transaction is at a merchant associated with fuel purchases with an MCC for fuel purchases and determine that the transaction belongs in a fuel purchases category or bucket of an account associated with the transaction. In this example, the transaction may be applied to the fuel purchases category or bucket and the available balance is updated based on an updated bucket total of the fuel purchases category or bucket. The updated available balance may be a real-time updated available balance with all real-time available information and/or calculations applied to the real-time available balance, including the approved transaction.

The line of credit engine may transmit 560 the updated available balance to the authorization engine. The authorization engine may receive the updated available balance from the line of credit engine. Transmitting the updated available balance to the authorization engine may include transmitting the real-time updated available balance to the authorization engine. In some implementations, the line of credit engine may transmit the updated available balance to the authorization engine in response to calculating the updated available balance. In some implementations, the line of credit engine may transmit the updated available balance to the authorization engine at regular intervals.

In some implementations, the available balance, the updated available balance, the real-time available balance, and/or the real-time updated available balance are each a single number. In this way, the authorization engine does not have to perform any calculations to obtain the available balance, the updated available balance, the real-time available balance, and/or the real-time updated available balance. In addition, sending the updated available balance, the real-time available balance, and/or the real-time updated available balance each as single numbers conserves network bandwidth and other network resources. Moreover, sending the updated available balance, the real-time available balance, and/or the real-time updated available balance each as single numbers allows for flexibility in receiving available balances from a variety of different line of credit engines, for a variety of different accounts, and for a variety of different account types. In some implementations, a common format is used for receiving the available balances. In an example, a JSON format is used for receiving the updated available balance, the real-time available balance, and/or the real-time updated available balance.

In some implementations, the authorization engine includes a first available balance associated with a first user and a second available balance associated with a second user. The authorization engine may include multiple available balances associated with multiple different users. The first available balance may be a different type of available balance than the second available balance. In an example, the first available balance is an available credit amount for a credit card and the second available balance is an available funds amount for a debit card or gift card. In this way, the authorization engine can aggregate authorizations for multiple different users.

In some implementations, the authorization engine includes a first available balance associated with an available credit amount and a second available balance associated with an available funds amount. In an example, the first available balance is an available credit amount for a credit card and the second available balance is an available funds amount for a debit card or gift card. The first available balance and the second available balance may be associated with accounts belonging to different users. In this way, the authorization engine aggregates transaction authorizations across multiple different users and account types.

In some implementations, the authorization engine receives available balances and/or updated available balances from a plurality of line of credit engines. The authorization engine may receive the available balances from the plurality of line of credit engines without having to calculate the available balances. By performing the calculations necessary to calculate the available balances at the plurality of line of credit engines, the authorization engine is able to aggregate available balances from the plurality of line of credit engines at scale. In this way, the authorization engine can include available balances from many more line of credit engines while conserving compute resources used by the authorization engine. As discussed herein, the available balances may be transmitted to the authorization engine each as single numbers, conserving network resources and also conserving compute resources at the authorization engine.

In some implementations, the authorization engine receives a plurality of transaction authorization requests from a plurality of issuing processors. The authorization engine may thus aggregate the plurality of authorization requests from the plurality of issuing processors at a single authorization engine. The authorization engine, in comparing transaction information against available balances, may simplify the authorization process compared to conventional systems, leading to lower latency, reduced usage of compute resources, and reduced usage of network resources.

In some implementations, the line of credit engine transmits and receives information from the authorization engine using a single communication channel. This may result in a more secure authorization pathway and reduced use of compute and network resources compared to conventional systems. Aggregating authorization requests from a plurality of issuing processors at the authorization engine allows for the available balance calculated at the line of credit engine to be compared to transaction information from the plurality of issuing processors without the line of credit having to establish a connection with each issuing processor. Instead, the line of credit engine can establish a single connection with the authorization engine and the authorization engine can authorize or deny authorization requests from the plurality of issuing processors. In this way, the available balance may be calculated only once at the line of credit engine, conserving compute resources, and the line of credit engine only needs a single communication channel with the authorization engine, conserving network resources.

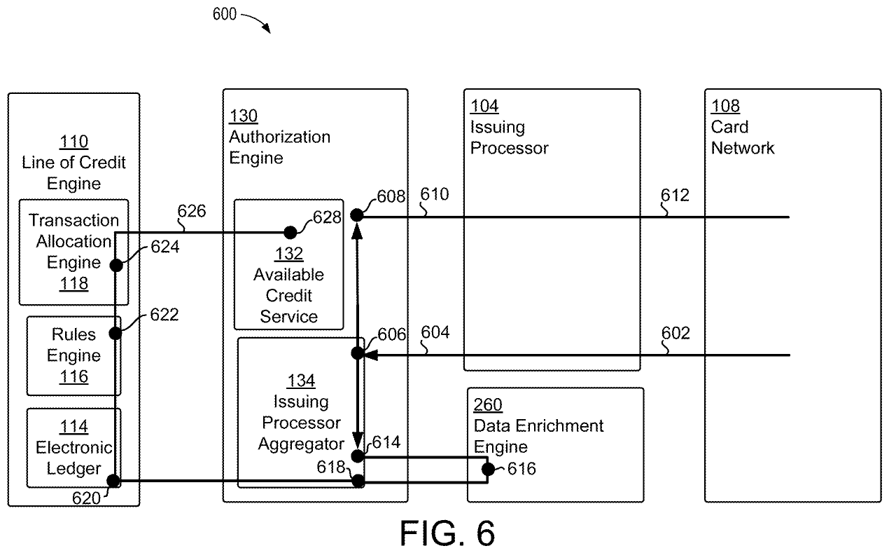

FIG. 6 is a flow diagram 600 depicting transaction management, according to some implementations. The flow diagram 600 can correspond to a flow of the method 500 of FIG. 5. The operations and messages described herein may be re-ordered, modified, adjusted, omitted, or further operations or messages may be included. Moreover, some messages or operations described herein in the singular can refer to multiple messages or operations, such as iterative or sequential operations or messages.

The card network 108 may provide an authorization request message 602 to the issuing processor 104 responsive to an attempted transaction. For example, the card network 108 can receive swipe data corresponding to the swipe action from a merchant, via one or more intermediaries, such as an acquiring provider.

Responsive to the receipt of the message 602 from the card network 108, the issuing processor 104 can provide a message 604 to the authorization engine 130. At operation 606, the issuing processor aggregator can approve or deny the transaction based on one or more transaction rules (e.g., a comparison of a transaction amount to a stored value or an available credit associated with a card). The authorization may not be an only or final approval. For example, the issuing processor 104 can generate a first determination of authorization (e.g., an authorization, non-authorization, pre-authorization, or other operation). Further, the issuing processor aggregator 134 can approve or deny the transaction based on one or more messages (not depicted) within the authorization engine 130. For example, the issuing processor aggregator 134 may compare an available balance received from the available credit service 132 to the transaction information.

At operation 608, the authorization engine 130 may transmit an authorization message 610 to the issuing processor 104. At operation 612, the issuing processor may transmit an authorization message 612 to the card network 108. In some implementations, the authorization message 610 and the authorization message 612 are the same.

At operation 614, the issuing processor aggregator 134 may, responsive to authorizing the transaction, transmit the transaction information to a data enrichment engine 260. The data enrichment engine may use the transaction information to generate enriched transaction record data (e.g., based on a predetermined lookup function or another determination of a deviation between a data field of the transaction record and a uniform field corresponding thereto). At operation 616, the data enrichment source 260 can provide the enriched transaction data based on the receipt of the transaction information from the issuing processor aggregator 134. The enrichment data source 260 can provide the enriched data to the authorization engine 130.

At operation 618, the issuing processor aggregator may transmit the enriched transaction information to the line of credit engine 110. At operation 620, the line of credit engine 110 receives the enriched transaction information. The line of credit engine 110 may update the electronic ledger using the enriched transaction information. At operation 622, the rules engine 116 applies one or more rules to the enriched transaction data to determine one or more categories or buckets for the transaction. At operation 624, the transaction allocation engine 118 allocates the transaction to the one or more categories or buckets and updates the available balance. The allocation engine 118 may update electronic ledger. At operation 624, the transaction allocation engine 118 may transmit the updated available balance 626 to the available credit service 132. At operation 628, the available credit service may store the updated available balance for comparison with transaction information of future transactions. The updated available balance 626 may be a real-time updated available balance, as discussed herein.

FIG. 7 illustrates an example computer system 700. The computer system 700 may be used, for example, to implement a issuing processor aggregator 134, line of credit engine 110, issuing processors 104, card networks 107, and/or various other example systems described in the present disclosure. The computing system 700 includes a bus 705 or other communication component for communicating information and a processor 710 coupled to the bus 705 for processing information. The computing system 700 also includes main memory 715, such as a random-access memory (RAM) or other dynamic storage device, coupled to the bus 705 for storing information, and instructions to be executed by the processor 710. Main memory 715 can also be used for storing position information, temporary variables, or other intermediate information during execution of instructions by the processor 710. The computing system 700 may further include a read only memory (ROM) 720 or other static storage device coupled to the bus 705 for storing static information and instructions for the processor 710. A storage device 725, such as a solid-state device, magnetic disk, or optical disk, is coupled to the bus 705 for persistently storing information and instructions.

The computing system 700 may be coupled via the bus 705 to a display 735, such as a liquid crystal display, or active matrix display, for displaying information to a user. An input device 730, such as a keyboard including alphanumeric and other keys, may be coupled to the bus 705 for communicating information, and command selections to the processor 710. In another implementation, the input device 730 has a touch screen display 735. The input device 730 can include any type of biometric sensor, a cursor control, such as a mouse, a trackball, or cursor direction keys, for communicating direction information and command selections to the processor 710 and for controlling cursor movement on the display 735.

In some implementations, the computing system 700 may include a communications adapter 740, such as a networking adapter. In various illustrative implementations, any type of networking configuration may be achieved using communications adapter 740, such as wired (e.g., via Ethernet), wireless (e.g., via Wi-Fi, Bluetooth), satellite (e.g., via GPS) pre-configured, ad-hoc, LAN, WAN.

According to various implementations, the processes that effectuate illustrative implementations that are described herein may be achieved by the computing system 700 in response to the processor 710 executing an implementation of instructions contained in main memory 715. Such instructions may be read into main memory 715 from another computer-readable medium, such as the storage device 725. Execution of the implementation of instructions contained in main memory 715 causes the computing system 700 to perform the illustrative processes described herein. One or more processors in a multi-processing implementation may also be operated to execute the instructions contained in main memory 715. In alternative implementations, hard-wired circuitry may be used in place of or in combination with software instructions to implement illustrative implementations. Thus, implementations are not limited to any specific combination of hardware circuitry and software.

That is, although an example processing system has been described in FIG. 7, implementations of the subject matter and the functional operations described in this specification may be carried out using other types of digital electronic circuitry, or in computer software embodied on a tangible medium, firmware, or hardware, including the structures disclosed in this specification and their structural equivalents, or in combinations of one or more of them. Implementations of the subject matter described in this specification may be implemented as one or more computer programs, e.g., one or more subsystems of computer program instructions, encoded on one or more computer storage medium for execution by, or to control the operation of, data processing apparatus. Alternatively, or in addition, the program instructions may be encoded on an artificially generated propagated signal, e.g., a machine generated electrical, optical, or electromagnetic signal, that is generated to encode information for transmission to suitable receiver apparatus for execution by a data processing apparatus. A computer storage medium may be, or be included in, a computer-readable storage device, a computer-readable storage substrate, a random or serial access memory array or device, or a combination of one or more of them. Moreover, while a computer storage medium is not a propagated signal, a computer storage medium may be a source or destination of computer program instructions encoded in an artificially generated propagated signal. The computer storage medium can also be, or be included in, one or more separate components or media (e.g., multiple CDs, disks, or other storage devices). Accordingly, the computer storage medium is both tangible and non-transitory.

Although shown in the implementations of FIG. 7 as singular, stand-alone devices, one of ordinary skill in the art will appreciate that, in some implementations, the computing system 700 may include virtualized systems and/or system resources. For example, in some implementations, the computing system 700 may be a virtual switch, virtual router, virtual host, or virtual server. In various implementations, computing system 700 may share physical storage, hardware, and other resources with other virtual machines. In some implementations, virtual resources of the network may include cloud computing resources such that a virtual resource may rely on distributed processing across more than one physical processor, distributed memory, etc.

Some example implementations, according to the present disclosure, are now described.

An example system may include one or more processors, and one or more non-transitory, computer-readable mediums including instructions which, when executed by the one or more processors, cause the system to receive, at an authorization engine, from an issuing processor, a transaction authorization request including transaction information, compare, by the authorization engine, the transaction information to an available balance, based on the comparison, transmit, by the authorization engine, to the issuing processor, an approval message, transmit, by the authorization engine, the transaction information to a line of credit engine, determine, by the line of credit engine, an updated available balance based on the transaction information, and transmit, by the line of credit engine, the updated available balance to the authorization engine.

In the example system, comparing, by the authorization engine, the transaction information to the available balance may include comparing a transaction amount to the available balance. In the example system, determining, by the line of credit engine, the updated available balance may include updating a balance category of the available balance. In the example system determining, by the line of credit engine, the updated available balance may include determining, based on the transaction information, a transaction category corresponding to the balance category. In the example system, the instructions may further cause the at least one of the one or more or more processors to transmit, by the authorization engine, the transaction information to a data enrichment engine, and receive, by the authorization engine, from the data enrichment engine, enriched transaction information, wherein transmitting the transaction information to the line of credit engine may include transmitting the enriched transaction information to the line of credit engine. In the example system, the authorization engine may include a first available balance associated with a first user and a second available balance associated with a second user. In the example system, the line of credit engine may transmit and receive information from the authorization engine using a single communication channel. In the example system, the authorization engine may include a first available balance associated with an available credit amount and a second available balance associated with an available funds amount. In the example system, the instructions may further cause the authorization engine to receive a plurality of transaction authorization requests from a plurality of issuing processors. In the example system, the instructions may further cause the authorization engine to receive updated available balances from a plurality of line of credit engines.

An example method may include receiving, by an authorization engine, from an issuing processor, a transaction authorization request including transaction information, comparing, by the authorization engine, the transaction information to an available balance, based on the comparison, transmitting, by the authorization engine, to the issuing processor, an approval message, transmitting, by the authorization engine, the transaction information to a line of credit engine, determining, by the line of credit engine, an updated available balance based on the transaction information, and transmitting, by the line of credit engine, the updated available balance to the authorization engine.

In the example method, comparing, by the authorization engine, the transaction information to the available balance may include comparing a transaction amount to the available balance. In the example method, comparing, by the authorization engine, the transaction information to the available balance may include comparing a transaction amount to a balance category of the available balance. In the example method, comparing, by the authorization engine, the transaction amount to a balance category of the available balance may include determining, based on the transaction information, a transaction category corresponding to the balance category. In the example method, the instructions may further cause the at least one of the one or more or more processors to transmit, by the authorization engine, the transaction information to a data enrichment engine, and receive, by the authorization engine, from the data enrichment engine, enriched transaction information, wherein transmitting the transaction information to the line of credit engine may include transmitting the enriched transaction information to the line of credit engine. In the example method, the authorization engine may include a first available balance associated with a first user and a second available balance associated with a second user. In the example method, the line of credit engine may transmit and receive information from the authorization engine using a single communication channel. In the example method, the authorization engine may include a first available balance associated with an available credit amount and a second available balance associated with an available funds amount. In the example method, the instructions may further cause the authorization engine to receive a plurality of transaction authorization requests from a plurality of issuing processors. In the example method, the instructions may further cause the authorization engine to receive updated available balances from a plurality of line of credit engines.

While this specification contains many specific implementation details, these should not be construed as limitations on the scope of any inventions or of what may be claimed, but rather as descriptions of features specific to particular implementations of the systems and methods described herein. Certain features that are described in this specification in the context of separate implementations can also be implemented and/or arranged in combination in a single implementation. Conversely, various features that are described in the context of a single implementation can also be implemented and arranged in multiple implementations separately or in any suitable sub combination. Moreover, although features may be described above as acting in certain combinations and even initially claimed as such, one or more features from a claimed combination can in some cases be excised from the combination, and the claimed combination may be directed to a subcombination or variation of a subcombination.

Additionally, features described with respect to particular headings may be utilized with respect to and/or in combination with illustrative implementations described under other headings; headings, where provided, are included solely for the purpose of readability, and should not be construed as limiting any features provided with respect to such headings.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims may be performed in a different order and still achieve desirable results. In addition, the processes depicted in the accompanying figures do not necessarily require the particular order shown, or sequential order, to achieve desirable results.

In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Having now described some illustrative implementations, implementations, illustrative embodiments, and embodiments, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements, and features discussed only in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations, arrangements, elements, or acts of the systems and methods herein referred to in the singular may also embrace implementations including a plurality of these elements, and any references in plural to any implementation, arrangement, element, or act herein may also embrace implementations including only a single element. References in the singular or plural form are not intended to limit the presently disclosed systems or methods, or their components, acts, or elements to single or plural configurations. References to any act or element being based on any information, act, or element may include implementations where the act or element is based at least in part on any information, act, or element.

Any implementation disclosed herein may be combined with any other implementation, and references to “an implementation,” “some implementations,” “an alternate implementation,” “various implementation,” “one implementation” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description, or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

It should be understood that no claim element herein is to be construed under the provisions of 35 U.S.C. § 112 (f) unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components, including, but not limited to, processing circuitry, network interfaces, peripheral devices, input devices, output devices, and sensors. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring.

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively, or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor. In some embodiments, the one or more processors may be external to the apparatus, for example the one or more processors may be a remote processor (e.g., a cloud based processor). Alternatively, or additionally, the one or more processors may be internal and/or local to the apparatus. In this regard, a given circuit or components thereof may be disposed locally (e.g., as part of a local server, a local computing system) or remotely (e.g., as part of a remote server such as a cloud based server). To that end, a “circuit” as described herein may include components that are distributed across one or more locations.

An exemplary system for implementing the overall system or portions of the embodiments might include a general purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps, and decision steps.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

The term “coupled” and variations thereof includes the joining of two members directly or indirectly to one another. The term “electrically coupled” and variations thereof includes the joining of two members directly or indirectly to one another through conductive materials (e.g., metal or copper traces). Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical (e.g., magnetic), or fluidic.

What is claimed is:

1. A system comprising:
one or more processors; and
one or more non-transitory, computer-readable mediums including instructions which, when executed by the one or more processors, cause the system to:
receive, at an authorization engine, from an issuing processor, a transaction authorization request including transaction information;
compare, by the authorization engine, the transaction information to an available balance;
based on the comparison, transmit, by the authorization engine, to the issuing processor, an approval message;
transmit, by the authorization engine, the transaction information to a line of credit engine;
determine, by the line of credit engine, an updated available balance based on the transaction information; and
transmit, by the line of credit engine, the updated available balance to the authorization engine.

2. The system of claim 1, wherein comparing, by the authorization engine, the transaction information to the available balance includes comparing a transaction amount to the available balance.

3. The system of claim 1, wherein determining, by the line of credit engine, the updated available balance includes updating a balance category of the available balance.

4. The system of claim 3, wherein determining, by the line of credit engine, the updated available balance includes determining, based on the transaction information, a transaction category corresponding to the balance category.

5. The system of claim 1, wherein the instructions further cause the at least one of the one or more or more processors to:
transmit, by the authorization engine, the transaction information to a data enrichment engine; and
receive, by the authorization engine, from the data enrichment engine, enriched transaction information, wherein transmitting the transaction information to the line of credit engine includes transmitting the enriched transaction information to the line of credit engine.

6. The system of claim 1, wherein the authorization engine includes a first available balance associated with a first user and a second available balance associated with a second user.

7. The system of claim 6, wherein the line of credit engine transmits and receives information from the authorization engine using a single communication channel.

8. The system of claim 1, wherein the authorization engine includes a first available balance associated with an available credit amount and a second available balance associated with an available funds amount.

9. The system of claim 1, wherein the instructions further cause the authorization engine to receive a plurality of transaction authorization requests from a plurality of issuing processors.

10. The system of claim 1, wherein the instructions further cause the authorization engine to receive updated available balances from a plurality of line of credit engines.

11. A method comprising:
receiving, by an authorization engine, from an issuing processor, a transaction authorization request including transaction information;
comparing, by the authorization engine, the transaction information to an available balance;
based on the comparison, transmitting, by the authorization engine, to the issuing processor, an approval message;
transmitting, by the authorization engine, the transaction information to a line of credit engine;
determining, by the line of credit engine, an updated available balance based on the transaction information; and
transmitting, by the line of credit engine, the updated available balance to the authorization engine.

12. The method of claim 11, wherein comparing, by the authorization engine, the transaction information to the available balance includes comparing a transaction amount to the available balance.

13. The method of claim 11, wherein comparing, by the authorization engine, the transaction information to the available balance includes comparing a transaction amount to a balance category of the available balance.

14. The method of claim 13, wherein comparing, by the authorization engine, the transaction amount to a balance category of the available balance includes determining, based on the transaction information, a transaction category corresponding to the balance category.

15. The method of claim 11, wherein the instructions further cause the at least one of the one or more or more processors to:
transmit, by the authorization engine, the transaction information to a data enrichment engine; and
receive, by the authorization engine, from the data enrichment engine, enriched transaction information, wherein transmitting the transaction information to the line of credit engine includes transmitting the enriched transaction information to the line of credit engine.

16. The method of claim 11, wherein the authorization engine includes a first available balance associated with a first user and a second available balance associated with a second user.

17. The method of claim 11, wherein the line of credit engine transmits and receives information from the authorization engine using a single communication channel.

18. The method of claim 11, wherein the authorization engine includes a first available balance associated with an available credit amount and a second available balance associated with an available funds amount.

19. The method of claim 11, wherein the instructions further cause the authorization engine to receive a plurality of transaction authorization requests from a plurality of issuing processors.

20. The method of claim 11, wherein the instructions further cause the authorization engine to receive updated available balances from a plurality of line of credit engines.
